(19) United States
(12) Patent Application Publication
(10) Pub. No.: US 2014/0034622 A1
(43) Pub. Date: Feb. 6, 2014

(54) METHOD AND SYSTEM FOR NARROW GROVE WELDING USING LASER AND HOT-WIRE SYSTEM

(71) Applicant: LINCOLN GLOBAL, INC., City of Industry, CA (US)

(72) Inventor: Mike BARRETT, North Royalton, OH (US)

(73) Assignee: LINCOLN GLOBAL, INC., City of Industry, CA (US)

(21) Appl. No.: 13/802,904

(22) Filed: Mar. 14, 2013

Related U.S. Application Data
(60) Provisional application No. 61/679,492, filed on Aug. 3, 2012.

(51) Int. Cl. B23K 26/20

(52) U.S. Cl. CPC B23K 26/203
USPC 219/121.64; 219/121.63; 219/137.2

(57) ABSTRACT

A system and method for narrow groove welding is provided. The system includes at least one laser emitting a laser beam to heat at least one of a first workpiece and a second workpiece to create at least one molten puddle. The system also includes at least one wire feeder feeding at least one wire to the at least one molten puddle. An edge of the first workpiece and an edge of the second workpiece are configured such that an alignment of the workpieces forms a first groove and a second groove. The first groove and the second groove are formed on opposite sides of the workpieces. For each groove, its depth is 50% to 75% of a thickness of the first workpiece or the second workpiece, a gap width at a surface of the workpieces is 1.5 to 2 times a diameter of the at least one wire, and a sidewall angle is a range of 0.5 to 10 degrees with respect to a centerline of the respective groove.

### PRIORITY

The present application claims priority to U.S. Provisional Patent Application No. 61/679,492 filed Aug. 3, 2012, which is incorporated herein by reference in its entirety.

### TECHNICAL FIELD

Certain embodiments relate to narrow groove welding and joining applications. More particularly, certain embodiments relate to the use of a laser and filler wire in a system and method for narrow groove welding and joining applications.

### BACKGROUND

The traditional hot filler wire method of welding (e.g., a gas-tungsten arc welding (GTAW) hot filler wire method) provides increased deposition rates and welding speeds over that of traditional arc welding alone. The filler wire, which leads a torch, is resistance-heated by a separate power supply. The wire is fed through a contact tube toward a workpiece and extends beyond the tube. The extension is resistance-heated such that the extension approaches or reaches the melting point and contacts the weld puddle. A tungsten electrode may be used to heat and melt the workpiece to form the weld puddle. The power supply provides a large portion of the energy needed to resistance-melt the filler wire. In some cases, the wire feed may slip or falter and the current in the wire may cause an arc to occur between the tip of the wire and the workpiece. The extra heat of such an arc may cause burnthrough and spatter.

In addition, it can be difficult to weld the bottom of the joint when arc welding deep joints (greater than 1 inch in depth). This is because it is difficult to effectively deliver shielding gas into such a deep groove and the narrow walls of the groove can cause interference with the stability of a welding arc. Further, because the workpiece is typically a ferrous material the walls of the joint can interfere, magnetically, with the welding arc. Because of this, when using typical arc welding procedures the width of the groove needs to be sufficiently wide so that the arc remains stable. However, the wider the groove, the more filler metal is needed to complete the weld.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise using a laser and filler wire in a system and method for narrow groove welding and joining applications. The system includes at least one laser emitting a laser beam to heat at least one of a first workpiece and a second workpiece to create at least one molten puddle. The system also includes at least one wire feeder feeding at least one wire to the at least one molten puddle. An edge of the first workpiece and an edge of the second workpiece are configured such that an alignment of the workpieces forms a first groove and a second groove. The first groove and the second groove are formed on opposite sides of the workpieces. For each groove, its depth is 50% to 75% of a thickness of the first workpiece or the second workpiece, a gap width at a surface of the workpieces is 1.5 to 2 times a diameter of the at least one wire, and a sidewall angle is a range of 0.5 to 10 degrees with respect to a centerline of the respective groove.

The method includes aligning an edge of a first workpiece to an edge of a second workpiece and heating at least one of the first workpiece and the second workpiece to create at least one molten puddle. The method also includes feeding at least one wire to said at least one molten puddle. The edge of the first workpiece and the edge of the second workpiece are configured such that the aligning forms a first groove and a second groove, which are formed on opposite sides of the workpieces.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a combination filler wire feeder and energy source system for narrow groove welding and joining applications;

FIG. 2 illustrates an exemplary embodiment of the grooves G, G′ of the system in FIG. 1;

FIG. 3 illustrates an exemplary embodiment of a joint between workpieces that is consistent with embodiments of the present invention; and

FIGS. 4A to 4C illustrate exemplary embodiments of a joint between workpieces that are consistent with other exemplary embodiments of the present invention.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

It is known that welding/joining operations typically join multiple workpieces together in a welding operation where a filler metal is combined with at least some of the workpiece metal to form a joint. Because of the desire to increase production throughput in welding operations, there is a constant need for faster welding operations, which do not result in welds which have a substandard quality. Furthermore, there is a need to provide systems that can weld quickly under adverse environmental conditions, such as in remote work sites. As described below, exemplary embodiments of the present invention provide significant advantages over existing welding technologies. Such advantages include, but are not limited to, reduced use of filler wire, reduced fabrication time, reduced total heat input resulting in low distortion of the workpiece, very high welding travel speeds, very low spatter rates, welding with the absence of shielding, welding plated or coated materials at high speeds with little or no spatter, and welding complex materials at high speeds.

Furthermore, many types of welding and joining applications use standard butt or v-notch groove joints to join the work pieces. However, these joint types can require great care when aligning the workpieces, and if they are misaligned the joint can be compromised or may need to be re-worked. However, embodiments of the present invention allow for the weld joint shape to be formed such that alignment can be optimized and made quicker, with less chance for misalignment.

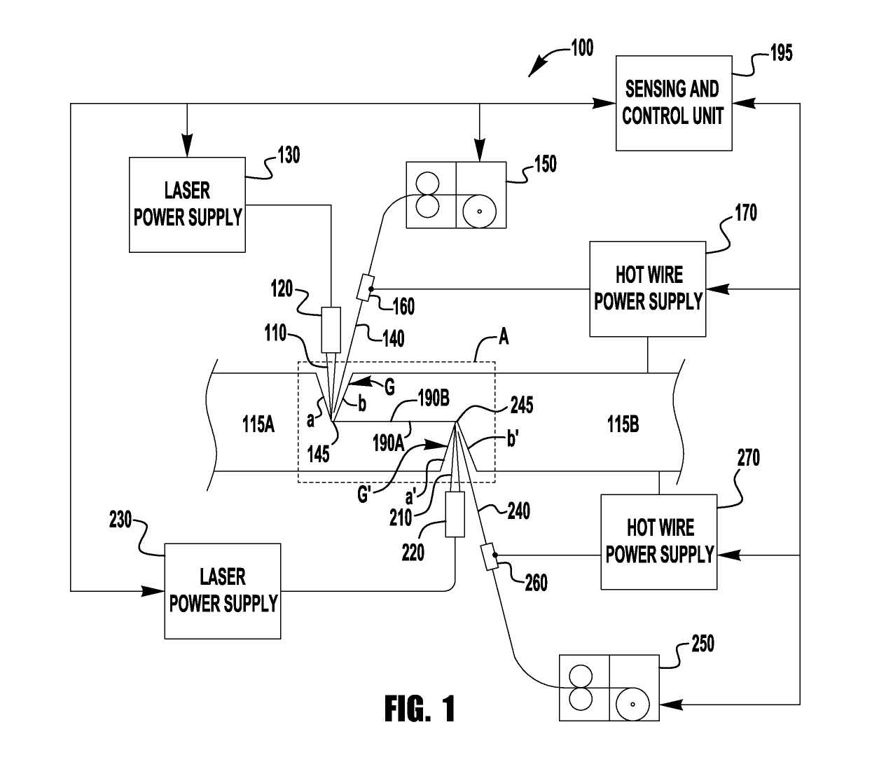

FIG. 1 illustrates a functional schematic block diagram of an exemplary embodiment of a combination filler wire feeder and energy source system 100 for performing joining/welding applications. The system 100 includes a laser subsystem 130/120 capable of focusing a laser beam 110 onto one side of workpieces 115A and 115B to form a weld puddle 145. System 100 also includes a laser subsystem 230/220 capable of focusing a laser beam 210 onto the other side of workpieces 115A and 115B to form a weld puddle 245. The laser subsystems are a high intensity energy sources and can be any type of high energy laser source, including but not limited to carbon dioxide, Nd:YAG, Yb-disk, YB-fiber, fiber delivered or direct diode laser systems. Further, even white light or quartz laser type systems can be used if they have sufficient energy. For example, a high intensity energy source can provide at least 500 W/cm².

It should be noted that the high intensity energy sources, such as the laser devices 120/220 discussed herein, should be of a type having sufficient power to provide the necessary energy density for the desired welding operation. That is, the laser devices 120/220 should have a power sufficient to create and maintain a stable weld puddle throughout the welding process, and also reach the desired weld penetration. Exemplary lasers should have power capabilities in the range of 1 to 20 kW, and may have a power capability in the range of 5 to 20 kW. Higher power lasers can be utilized, but can become very costly.

Each laser subsystem includes a laser devices 120 or 220 and laser power supply 130 or 230. The laser devices are operatively connected to their respective power supplies. The laser power supplies 130/230 provide power to operate the respective laser devices 120/220. The laser devices 120/220 allow for precise control of the size and depth of the respective weld puddles 145/245 as the laser beams 110/220 can be focused/de-focused easily or have the beam intensities changed very easily. Because of these abilities, the heat distribution on the workpieces 115A/115B can be precisely controlled. This control allows for the creation of the very narrow weld puddles that are important for the deep groove type welding of the present invention.

The system 100 also includes filler wire feeder subsystems capable of providing at least one resistive filler wire to each side of the workpieces 115A/115B. For example, wire 140 makes contact with the workpieces 115A/115B in the vicinity of the laser beam 110, and wire 240 makes contact with the other side of workpieces 115A/115B in the vicinity of the laser beam 210. Of course, it is understood that by reference to the workpieces 115A/115B herein, the weld puddles 145/245 are considered part of the workpieces 115A/115B. Thus, reference to contact with the workpieces 115A/115B includes contact with the appropriate weld puddle 145/245 or puddles. Each filler wire feeder subsystem includes a filler wire feeder 150 and 250, a contact tube 160 and 260, and a wire power supply 170 and 270. During operation, the filler wires 140/240 are resistance-heated by electrical current from the power supplies 170/270, respectively. The power supplies 170/270 are respectively connected between the contact tube 160/260 and the appropriate side of workpieces 115A/115B. In accordance with an embodiment of the present invention, the power supplies 170/270 are pulsed direct current (DC) power supplies, although alternating current (AC) or other types of power supplies are possible as well. In some exemplary embodiments, the filler wires 140/240 are respectively preheated by power supplies 170/270 to at or near their melting points. Accordingly, the presence of the wires 140/240 in their respective weld puddles 145/245 will not appreciably cool or solidify the puddles and the filler wires 140/240 will be quickly consumed into the puddles.

The power supplies 170/270, filler wire feeders 150/250, and laser power supplies 130/230 may be operatively connected to sensing and control unit 195. The control unit 195 can control the welding operations such as wire feed speeds, wire temperatures, and the temperatures of the weld puddles—to name just a few. To accomplish this, the control unit 195 can receive inputs such as the power used by power supplies 130, 230, 170, and 270, the voltage at contact tubes 160 and 260, the heating currents through the filler wires 140 and 240, the desired and actual temperatures for the filler wires 140 and 240, etc. Application Ser. No. 13/212,025, titled “Method And System To Start And Use Combination Filler Wire Feed And High Intensity Energy Source For Welding,” filed Aug. 17, 2011, and incorporated by reference in its entirety, describes exemplary sensing and control units, including exemplary monitoring and control algorithms, that may be incorporated in the present invention. Accordingly, for brevity, the sensing and control unit 195 will not be further discussed. Furthermore, the above referenced application discusses the general operation and control of a hot-wire filler system which can be used with embodiments of the present invention, and those descriptions will not be repeated herein, as the above referenced application is incorporated herein by reference in its entirety.

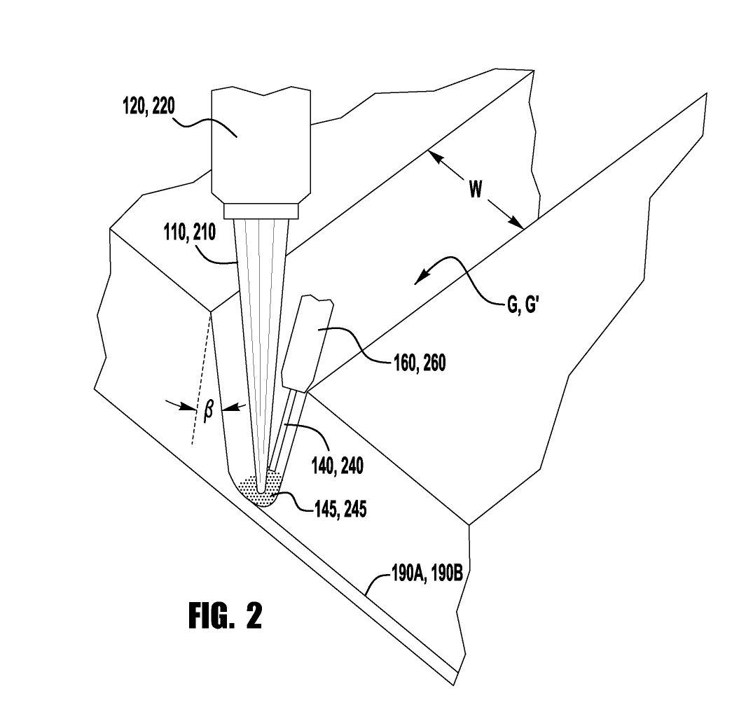

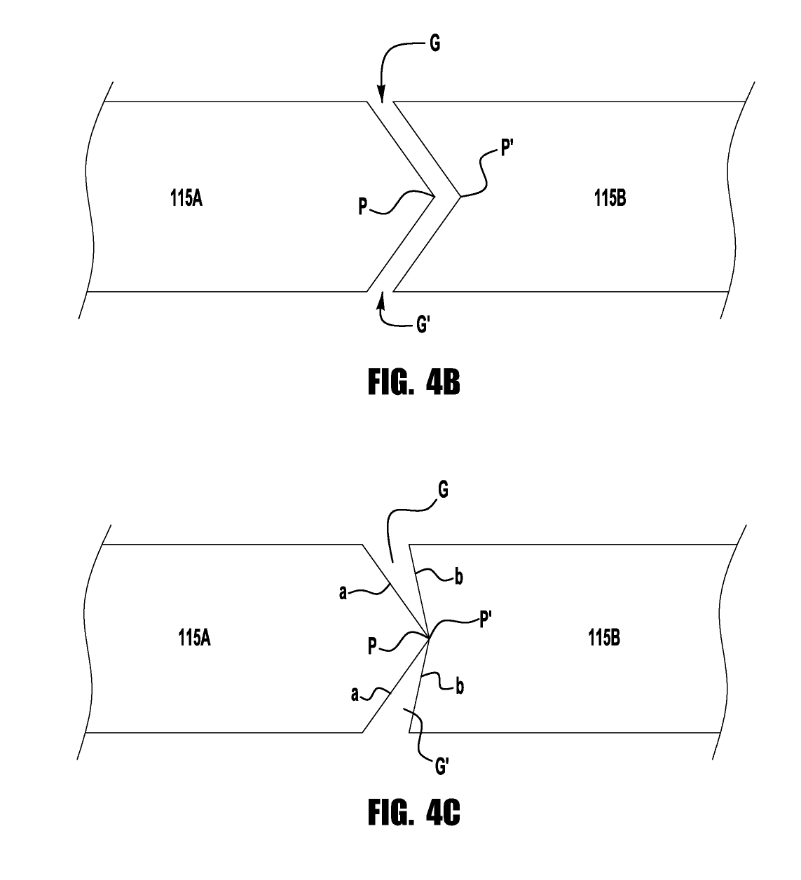

In preparation for welding, edges a and a′ of workpiece 115A and edges b and b′ of workpiece 115B have been prepped such that, once the workpieces 115A and 115B are fitted together to form joint A, the joint A will have grooves G and G′. In exemplary embodiments, grooves G and G′ are relatively narrow and deep when compared to a typical welding joint. For example, in an exemplary embodiment of the present invention where the workpieces 115A/115B have a thickness greater than 1 inch. The groove depth will be dependent on the thickness of the workpiece, but can be in the order of 50% to 75% of this thickness. Because each groove need only be 50% to 75% of the thickness of the workpiece, thicker workpieces can be welded than if the groove extended the entire thickness of the workpieces. As illustrated in FIG. 2, in some exemplary embodiments, the gap width W (at the surface of the workpiece) of each groove G/G′ is in the range of 1.5 to 2 times the diameter of the filler wire 140/240 and the sidewall angle β is in the range of 0.5 to 10 degrees. For grooves that are angled (e.g., see FIG. 4A), the sidewall angle β will be with respect to a centerline of the groove. Because the grooves G and G′ are smaller than a typical groove used in a normal arc welding process, grooves G and G′ can be welded faster and with much less filler material than in the normal arc welding process. In addition, because aspects of the present invention introduce much less heat into the welding zone, the contact tubes 160/260 can be designed to facilitate much closer delivery to the respective weld puddles 145/245 to avoid contact with the side wall. That is, as shown in FIG. 2, the contact tubes 160/260 can be made smaller and constructed as an insulated guide with a narrow structure. In some exemplary embodiments, a translation device or mechanism can be used to move the lasers 120/220 and the wires 140/240 across the width of the weld to weld both sides of the weld joint at the same time.

Thus, as shown in FIG. 1, the workpieces 115A/115B have an end shape—at the location of the weld joint—which allows them to be easily aligned. That is, each of the workpieces 115A/115B, respectively, have surfaces 190A/190B which interact with each other when the workpieces 115A/115B are joined together. These surfaces 190A/190B aid in matching the workpieces 115A/115B together to create the desired alignment between the workpieces. When the workpieces 115A/115B are joined the surfaces 190A/190B extend between the gaps G and G′. Of course, the shape or orientation of the surfaces 190A/190B can be made as desired to ensure a proper alignment is achieved.

In the exemplary embodiment shown in FIG. 1, a separate wire feeder 250 and laser 220 are used to simultaneously weld on each groove G/G′ of joint A. However, in some embodiments, a single laser/wire feed system, which welds on one groove at a time, can be used. In other embodiments, a single laser with the appropriate optics may be used instead of separate lasers 120/220 to simultaneously weld on each groove G/G′ of joint A. In the exemplary embodiments described above, out-of-position welding may be required on one or both side of the joint A. Techniques such as controlling the intensity of the laser beam, the wire feed speed, and heating current through the wire can help minimize the sagging of the weld puddle.

The narrow grooves in the exemplary embodiments of the present invention allow for joint designs that help make the fabrication process quicker. For example, the typical welding joint has a gap in the root pass of the joint. Prior to welding, the two pieces have to be carefully aligned to ensure that the gap is the same along the length of the workpiece. In addition, the pieces may have to be tack-welded in order to ensure that the pieces stay in alignment during the main welding process. In some embodiments of the present invention, the need to carefully align and tack-weld the pieces may be eliminated because the joint design is self-aligning. For example, the joint A in FIG. 1 is self-aligning. The workpieces 115A and 115B are designed such that the bottom of sides a and b and the bottom of sides a′ and b′ abut against each other when the two workpieces 115A/115B are fitted in preparation for welding. This joining can be facilitated by surfaces 190A and 190B. Because there is no or a minimal gap between the workpieces, the time required to align and tack-weld the workpieces may be eliminated. In exemplary embodiments of the present invention, there is no gap between the surfaces 190A and 190B such that they are flush with each other. In other embodiments, gaps can exist between these surfaces, so long as alignment can be properly achieved. In further exemplary embodiments, an adhesive can be applied between these surfaces.

In yet other exemplary embodiments, a spacer can be placed between the surfaces 190A/190B to separate the workpieces 115A/115B from each other. The spacer can be of a similar material to the workpieces or can be different. For example, the spacer can be of a composition or material that allows dissimilar metals to be joined, where workpiece 115A is a different metal than workpiece 115B.

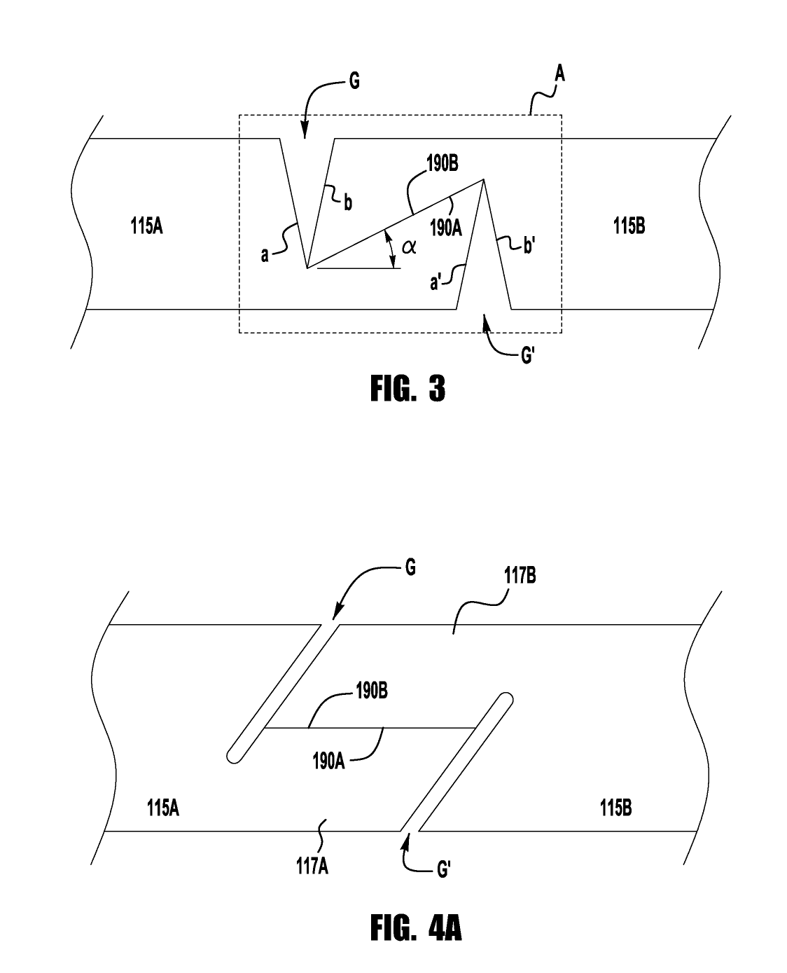

Similarly, FIG. 3 illustrates other self-aligning workpieces. In FIG. 3 the joint A is formed at an angle a. By forming the joint at an angle, the metallurgical bond area between the two workpieces is greater than if the grooves were perpendicular to the surface of the workpiece because the grooves G and G′ are deeper. Accordingly, the weld strength of such as joint can be greater than the traditional joint. The angle a is greater than 0 and can be up to and including 60%.

In other exemplary embodiments of the present invention, the shape of the weld joint and the workpieces at the joint can vary and still provide the self-aligning attributes described herein. For example, FIGS. 4A to 4C illustrate exemplary joint shapes that employ a narrow groove width design that enjoy many of the benefits discussed above such as: self-aligning, using less filler materials than the traditional weld and providing metallurgical bond areas that are greater than the traditional weld—to name just a few. As an example, the joint in FIG. 4A uses angled gaps G and G′ as shown, and the gaps G/G′ have a depth that extend beyond the surfaces 190A and 190B. Thus, similar to FIG. 3 the depth of the gaps G and G′ provide for additional surface area being joined. In exemplary embodiments of the present invention, the depths of the respective gaps do not extend beyond 75% of the thickness of the workpieces, regardless of the relative location of the surfaces 190A and 190B to the bottom of the gaps G and G′. Of course, in other exemplary embodiments, the gaps G and G′ can be angled in opposite directions, as opposed to being angled similarly as shown in FIG. 4A.

Further, although the embodiments depicted herein show that the workpieces 115A and 115B—at the joint—are relatively symmetrical, other embodiments can have a non-symmetrical configuration. For example, the thickness of the workpiece extension 117A can be thicker or thinner than the workpiece extension 117B. Moreover, the workpieces themselves need not have the same thicknesses or geometry. The joint and workpieces can be configured so that an acceptable joint is created.

FIG. 4B depicts another exemplary embodiment of the invention, which allows for easy alignment, where the workpiece 115A has a protrusion portion which mates with a receiving portion P′ on workpiece 115B to allow for the easy alignment of the workpieces. The resultant gaps G and G′ are relatively narrow and can then be welded as described and incorporated herein. Of course, other joint configurations and geometries can be utilized to allow for ease of alignment. FIG. 4C is another exemplary embodiment where the protrusion P mates with the protrusion P′, but the angling of the walls a is different than that of the walls b such that contact is made at point P/P′ but gaps G and G′ are created to allow for the welding operation. In FIG. 4C the protrusion portion P and receiving portion P′ represent essentially a point contact, but in other embodiments, the protrusion P can have other shapes than that shown which allow for alignment and receiving by a receiving portion P′.

In FIG. 1, the laser power supplies 130/230, hot wire power supplies 170/270, wire feeder 150/250, and sensing and control unit 195 are shown separately for clarity. However, in embodiments of the invention these components can be made integral into a single welding system. Aspects of the present invention do not require the individually discussed components above to be maintained as separately physical units or stand alone structures.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A system for narrow groove welding, said system comprising:
a first workpiece that is to be joined to a second workpiece;
a laser system that comprises at least one laser emitting a laser beam to heat at least one of said first workpiece and said second workpiece to create at least one molten puddle; and
a wire feeder system comprising at least one wire feeder feeding at least one wire to said at least one molten puddle,
wherein an edge of said first workpiece and an edge of said second workpiece are configured such that an alignment of said edge of said first workpiece with said edge of said second workpiece forms a first groove and a second groove,
wherein said first groove and said second groove are formed on opposite sides of said alignment of said first workpiece and said second workpiece,
wherein said creation of said at least one molten puddle is in at least one of said first groove and said second groove,
wherein for each of said first groove and said second groove,
a depth is 50% to 75% of a thickness of said first workpiece or said second workpiece,
a gap width at a surface of said alignment of said first workpiece and said second workpiece is 1.5 to 2 times a diameter of said at least one wire, and
a sidewall angle is a range of 0.5 to 10 degrees with respect to a centerline of said first groove or said second groove, respectively.

2. The system of claim 1, further comprising:
at least one power supply to heat said at least one wire to at or near a melting temperature of said at least one wire.

3. The system of claim 1, wherein said system is configured to weld one groove at a time.

4. The system of claim 1, wherein said system is configured to simultaneously weld said first groove and said second groove.

5. The system of claim 4, wherein said at least one laser comprises a first laser and a second laser to perform said simultaneous welding.

6. The system of claim 4, wherein said at least one laser comprises one laser and an optical system that directs said laser beam to said first groove and said second groove to perform said simultaneous welding.

7. The system of claim 2, wherein a welding of at least one of said first groove and said second groove is out-of-position welding, and
wherein at least one of an intensity of said laser beam, a feed speed of said at least one wire, and a heating of said at least one wire is controlled to minimize sagging of molten metal in said out-of-position weld.

8. The system of claim 1, wherein said first workpiece self-aligns to said second workpiece in a least one direction when said first workpiece is abutted against said second workpiece.

9. The system of claim 8, wherein said self-alignment comprises alignment of surfaces of said first workpiece and said second workpiece after said abutment.

10. The system of claim 8, wherein said self-alignment comprises alignment of said gap width after said abutment.

11. A method of narrow groove welding, said method comprising:
aligning an edge of a first workpiece to an edge of a second workpiece;
heating at least one of said first workpiece and said second workpiece to create at least one molten puddle; and
feeding at least one wire to said at least one molten puddle,
wherein said edge of said first workpiece and said edge of said second workpiece are configured such that said aligning forms a first groove and a second groove,
wherein said first groove and said second groove are formed on opposite sides of said alignment of said first workpiece and said second workpiece,
wherein said creation of said at least one molten puddle is in at least one of said first groove and said second groove,
wherein for each of said first groove and said second groove,
a depth is 50% to 75% of a thickness of said first workpiece or said second workpiece,
a gap width at a surface of said alignment of said first workpiece and said second workpiece is 1.5 to 2 times a diameter of said at least one wire, and
a sidewall angle is a range of 0.5 to 10 degrees with respect to a centerline of said first groove or said second groove, respectively.

12. The method of claim 11, further comprising:
heating said at least one wire to at or near a melting temperature of said at least one wire.

13. The method of claim 11, further comprising:
welding said second groove after welding said first groove.

14. The method of claim 11, further comprising:
simultaneously welding said first groove and said second groove.

15. The method of claim 14, wherein said simultaneous welding is performed using two lasers.

16. The method of claim 14, wherein said said simultaneous welding is performed using a laser and an optical system that directs a laser beam to said first groove and said second groove.

17. The method of claim 12, further comprising:
performing out-of-position welding on at least one of said first groove and said second groove,
wherein at least one of an intensity of said heating of said at least one of said first workpiece and said second workpiece, a feed speed of said at least one wire, and a heating of said at least one wire is controlled to minimize sagging of molten metal in said out-of-position weld.

18. The method of claim 11, wherein said first workpiece self-aligns to said second workpiece in a least one direction when said first workpiece is abutted against said second workpiece.

19. The method of claim 18, wherein said self-alignment comprises alignment of surfaces of said first workpiece and said second workpiece after said abutment.

20. The method of claim 18, wherein said self-alignment comprises alignment of said gap width after said abutment.
